(19) United States
(12) Patent Application Publication
(10) Pub. No.: US 2007/0292041 A1
(43) Pub. Date: Dec. 20, 2007

(54) Image processing apparatus, image forming apparatus, and image processing method

(75) Inventor: Shinsaku Ito, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/454,953

(22) Filed: Jun. 16, 2006

(51) Int. Cl. G06K 9/40

(52) U.S. Cl. 382/254

(57) ABSTRACT

An image processing technique is provided, by which a quantity of enhancement can be controlled in response to the characteristic of an image by a simple configuration.

A first filter processing unit configured to apply smoothing processing on image signals of respective pixels forming an image subject to processing; a second filter processing unit configured to apply processing to enhance a particular image frequency band on the image signals; a conversion information selection unit configured to select, according to discrimination information used to discriminate kinds of image formed of the respective pixels forming the image subject to processing from one, another, conversion information corresponding to the discrimination information among plural kinds of specific conversion information used to convert quantities of enhancement of the image signals of the respective pixels on which enhancement processing has been applied in the second filter processing unit; an enhancement quantity conversion unit configured to convert the quantities of enhancement of the image signals on which the enhancement processing has been applied in the second filter processing unit according to the conversion information selected in the conversion information selection unit; and a signal synthesis unit configured to synthesize, pixel by pixel, the image signals on which the smoothing processing has been applied in the first filter processing unit and the image signals whose quantities of enhancement have been converted in the enhancement quantity conversion unit, are included.

### BACKGROUND OF THE INVENTION

1. Field of the Invention

The present invention relates to an image processing technique, and more particularly, to a filtering technique for applying specific filter processing on an image.

2. Description of the Related Art

In an image processing apparatus, such as a copying machine, filter processing is performed as one processing to correct an image read by the reading device. The filter processing is characterized by the moire suppression effect for a periodic structure, such as halftone dots, achieved by controlling a gain in response to an image space frequency (smoothing of halftone dots by weakening enhancement of the image space frequency corresponding to the frequency of halftone screen of printed matter used as the document), and the sharpness effect for a character edge in contone (image).

There has been an image processing apparatus capable of switching filter coefficient parameters representing the frequency characteristic that varies with a discrimination signal from a discrimination processing unit that discriminates the characteristics between images, such as a photograph and a text, and for example, it is capable of setting a filter coefficient to increase the effect of moire suppression for a photograph portion in the document while setting a filter coefficient to increase the effect of character edge sharpness for a character portion (JP-A-2003-248821).

According to the image processing apparatus in the related art as described above, it is possible to suppress moire without the need of excessive unsharpness processing by making it possible to select a filter coefficient having an appropriate frequency characteristic in response to a sampling rate and a processing flow of an input image signal.

The sharpness effect for a character edge is one of effects expected to be achieved by the filter processing. According to the filter processing in the related art, however, there is a limit on the control of a quantity of enhancement because smoothing and enhancement are performed by a single filter, and there is a function to uniformly enhance a portion where the value of an image signal varies considerably in continuous grayscale. This may give rise to a case where enhancement is applied excessively to a portion where enhancement is not preferred, such as a patch edge (an edge portion of a patch region having uniform density).

### SUMMARY OF THE INVENTION

The present invention was devised to solve the problems discussed above, and therefore has an object to provide an image processing technique for enabling a quantity of enhancement to be controlled in response to the characteristic of an image using a simple configuration.

In order to solve the problems discussed above, an image processing apparatus of the invention includes: a first filter processing unit configured to apply smoothing processing on image signals of respective pixels forming an image subject to processing; a second filter processing unit configured to apply processing to enhance a particular image frequency band on the image signals; a conversion information selection unit configured to select, according to discrimination information used to discriminate kinds of image formed of the respective pixels forming the image subject to processing from one another, conversion information corresponding to the discrimination information among plural kinds of specific conversion information used to convert quantities of enhancement of the image signals of the respective pixels on which enhancement processing has been applied in the second filter processing unit; an enhancement quantity conversion unit configured to convert the quantities of enhancement of the image signals on which the enhancement processing has been applied in the second filter processing unit according to the conversion information selected in the conversion information selection unit; and a signal synthesis unit configured to synthesize, pixel by pixel, the image signals on which the smoothing processing has been applied in the first filter processing unit and the image signals whose quantities of enhancement have been converted in the enhancement quantity conversion unit.

In order to solve the problems discussed above, an image processing apparatus of the invention includes: first filter processing means for applying smoothing processing on image signals of respective pixels forming an image subject to processing; second filter processing means for applying processing to enhance a particular image frequency band on the image signals; conversion information selecting means for selecting, according to discrimination information used to discriminate kinds of image formed of the respective pixels forming the image subject to processing from one another, conversion information corresponding to the discrimination information among plural kinds of specific conversion information used to convert quantities of enhancement of the image signals of the respective pixels on which enhancement processing has been applied in the second filter processing means; enhancement quantity converting means for converting the quantities of enhancement of the image signals on which the enhancement processing has been applied in the second filter processing means according to the conversion information selected in the conversion information selecting means; and signal synthesizing means for synthesizing, pixel by pixel, the image signals on which the smoothing processing has been applied in the first filter processing means and the image signals whose quantities of enhancement have been converted in the enhancement quantity converting means.

In order to solve the problems discussed above, an image forming apparatus of the invention includes the image processing apparatus configured as above, and an image forming unit configured to form an image on a sheet according to the image signal synthesized in the signal synthesis unit.

In order to solve the problems discussed above, an image processing method of the invention includes the steps of: applying smoothing processing on image signals of respective pixels forming an image subject to processing as first filter processing; applying processing to enhance a particular image frequency band on the image signals as second filter processing; selecting, according to discrimination information used to discriminate kinds of image formed of the respective pixels forming the image subject to processing from one another, conversion information corresponding to the discrimination information among plural kinds of specific conversion information used to convert quantities of enhancement of the image signals of the respective pixels on which enhancement processing has been applied in the second filter processing step; converting the quantities of enhancement of the image signals on which the enhancement processing has been applied in the second filter processing step according to the conversion information selected in the conversion information selecting step; and synthesizing, pixel by pixel, the image signals on which the smoothing processing has been applied in the first filter processing step and the image signals whose quantities of enhancement have been converted in the enhancement quantity converting step.

### DESCRIPTION OF THE DRAWINGS

FIG. 1 is a functional block diagram used to describe an image processing apparatus 1 and an MFP (Multi Function Peripheral) M including the same according to one embodiment.

FIG. 2 is a view showing a frequency characteristic indicated by a filter coefficient set in a low-pass filter 102.

FIG. 3 is a view showing a frequency characteristic indicated by a filter coefficient set in a band-pass filter 103.

FIG. 4 is a view showing a difference in quantity of enhancement between pixels forming characters and pixels forming an edge portion of the patch region.

FIG. 5 is a view showing one example of an LUT selected in a conversion information selection unit.

FIG. 6 is a view showing a difference between LUT's for color characters and black characters.

FIG. 7 is a flowchart used to describe the flow of processing (image processing method) in the image processing apparatus according to one embodiment.

### DESCRIPTION OF THE EMBODIMENTS

Hereinafter, embodiments of the invention will be described with reference to the drawings.

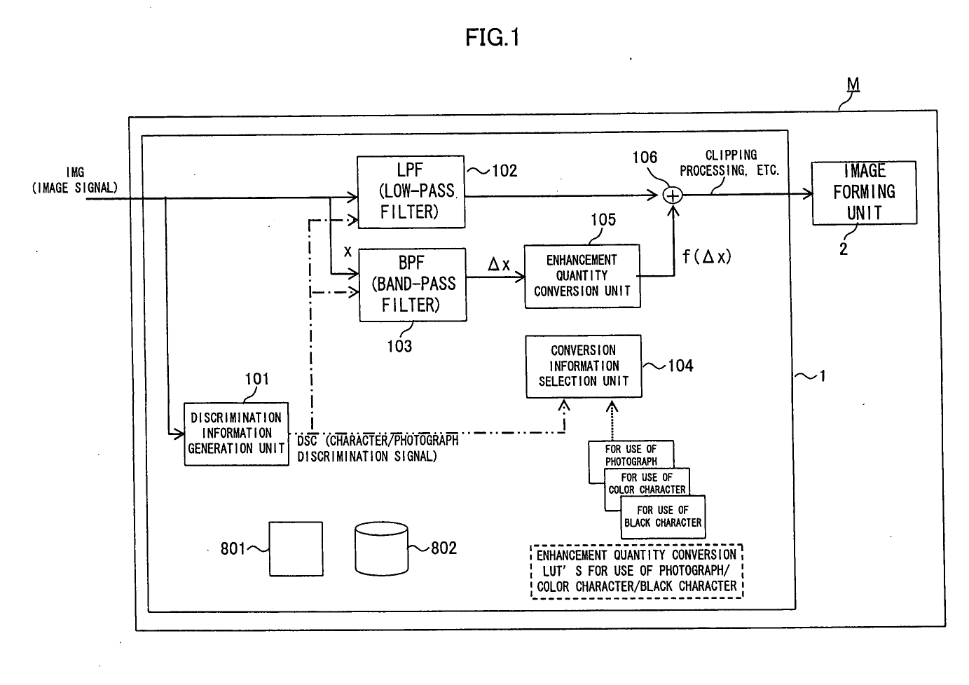

FIG. 1 is a functional block diagram used to describe an image processing apparatus 1 and an MFP (Multi Function Peripheral) M including the same according to one embodiment.

The MFP M according to this embodiment comprises the image processing apparatus 1 and an image forming unit 2. The image processing apparatus 1 plays a role of applying specific filtering processing on an image signal of an image subject to processing. Also, the image forming unit 2 plays a role of performing image forming processing on a sheet according to a processing result in the image processing apparatus 1. As the image signal of an image subject to processing referred to herein, data obtained by applying several kinds of specific processing on image data (so-called raw data) outputted directly from a CCD or the like will be described by way of example; however, raw data itself may be used as an image signal of the image subject to processing.

Hereinafter, the configuration of the image processing apparatus 1 according to this embodiment will be described in detail. The image processing apparatus 1 according to this embodiment comprises a discrimination information generation unit 101, a low-pass filter (first filter processing unit) 102, a band-pass filter (second filter processing unit) 103, a conversion information selection unit 104, an enhancement quantity conversion unit 105, a signal synthesis unit 106, a CPU 801, and a memory 802.

The discrimination information generation unit 101 generates a DSC signal (discrimination information) to discriminate kinds of image formed of respective pixels from one another by performing at least any one of “edge detection processing”, “achromatic color judgment processing”, and “halftone dot judgment processing” on image signals of pixels forming an image subject to processing. The DSC signal generated in the discrimination information generation unit 101 is the information to discriminate pixels forming an image (equivalent to an image of individual characters and photographs contained in an image subject to processing) of at least any one of “black character”, “color character”, and “photograph” from the others. For an image signal identified as forming a character, the discrimination information generation unit 101 compares the values of image signals of respective colors including RGB or CMY, and judges the image signal as forming a black character when a difference among the signal values is within the pre-set threshold value, after which it classifies the DSC signal into “black character” and “color characters”. The DSC signal generated in the discrimination information generation unit 101 is transmitted to the low-pass filter 102, the band-pass filter 103, and the conversion information selection unit 104 that will be described below.

The low-pass filter (first filter processing unit) 102 applies smoothing processing on image signals of respective pixels forming an image subject to processing. Of the RGB or CMY image signals, DC (direct current) smoothed by the filter processing in the low-pass filter 102 alone is extracted and outputted.

The band-pass filter (second filter processing unit) 103 is also referred to as a high-pass filter and applies processing to enhance a particular image frequency band on an image signal. To be more concrete, the second filter processing unit 103 applies enhancement processing to enhance image signals of pixels forming characters in an image subject to processing in comparison with image signals of pixels forming an edge portion of a patch region having uniform density, such as a filled-in figure. For an image signal IMG inputted into the band-pass filter 103, it is set in such a manner that a total of filter coefficients will be 0, and an enhancement component, Δx, alone is extracted.

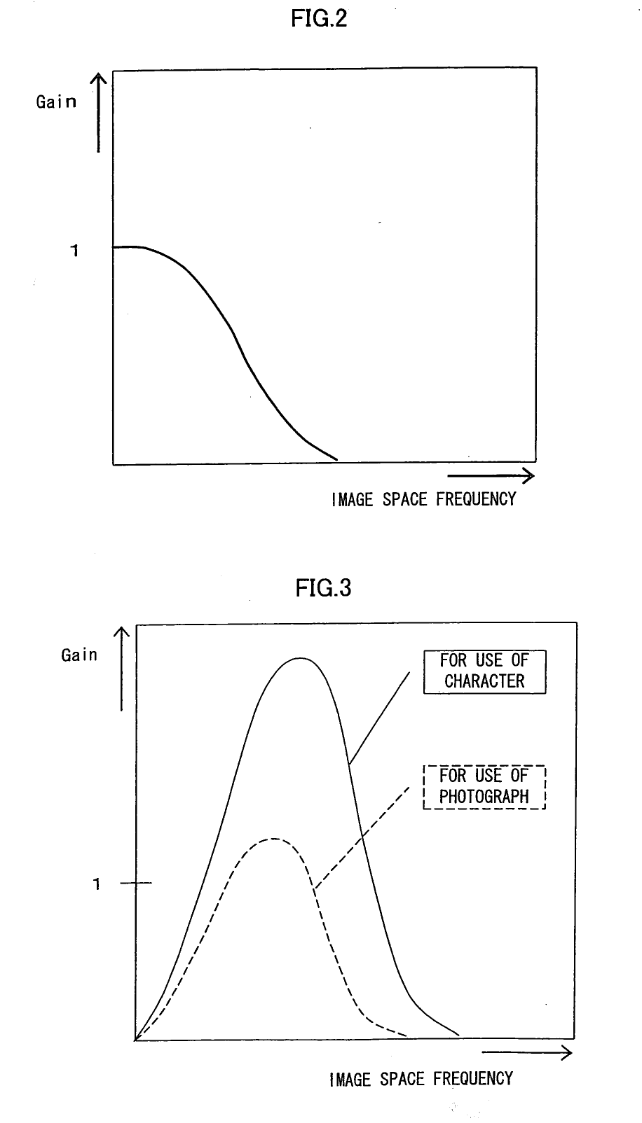

The low-pass filter 102 and the band-bass filter 103 acquire the DSC signal generated in the discrimination information generation unit 101, and perform specific filter processing by changing the parameter of the filter coefficient according to this DSC signal. FIG. 2 shows the frequency characteristic indicated by the filter coefficient set in the low-pass filter 102, and FIG. 3 shows the frequency characteristic indicated by the filter coefficient set in the band-pass filter 103. In these cases, the filter coefficient in the band-pass filter 103 is used for different uses: for the use of “character” and for the use of “photograph”. For the use of “character”, a quantity of enhancement is large because the peak of the gain is high, and for the use of “photograph”, the moire suppression effect is high because the peak is controlled to stay low and the cut-off frequency is also low. The band-pass filter 103 uses the filter coefficient for different uses according to the DSC signal.

The conversion information selection unit 104 acquires the DSC signal generated in the discrimination information generation unit 101. According to the acquired “DSC signal”, the conversion information selection unit 104 selects an LUT (Look-Up Table) corresponding to this DSC signal among plural LUT's (specific conversion information) to convert quantities of enhancement for image signals of respective pixels on which the enhancement processing has been applied in the second filter processing unit 103. Herein, three kinds of LUT's for uses of “photograph”, “color character”, and “black characters” have been previously prepared and stored, for example, in the memory 802.

The enhancement quantity conversion unit 105 converts a quantity of enhancement of an image signal on which the enhancement processing has been applied in the second filter processing unit 103 according to the LUT selected in the conversion information selection unit 104. To be more concrete, for example, of the image signals on which the enhancement processing has been applied in the second filter processing unit 103, the enhancement quantity conversion unit 105 reduces a quantity of enhancement of image signals of pixels forming the edge portion of the patch region according to the LUT selected in the conversion information selection unit 104.

The signal synthesis unit 106 adds and thereby synthesizes, pixel by pixel, an image signal on which the smoothing processing has been applied in the first filter processing unit 102 and an image signal whose quantity of enhancement has been converted in the enhancement quantity conversion unit 105. The image signal synthesized in the signal synthesis unit 106 undergoes specific processing, such as clipping processing, and is then transmitted to the image forming unit 2 described below.

The CPU 801 plays a role of performing various kinds of processing in the image processing apparatus 1 and in the MFP M, and also plays a role of exerting various functions by executing a program stored in the memory 802. The memory 802 comprises, for example, a ROM or a RAM, and plays a role of storing various kinds of information and programs used in the image processing apparatus 1.

The image forming unit 2 forms an image on a sheet according to an image signal for which the filtering processing in the image processing apparatus 1 has been completed (synthesized in the signal synthesis unit 106) as described above.

The image processing apparatus 1 according to this embodiment is able to convert the degree of enhancement non-linearly in response to an image signal level (quantity of enhancement) after the filter processing in the band-pass filter 103 with the use of the LUT. It is thus possible to adjust the degree of enhancement by discriminating between “pixels forming the edge portion of the patch regions” and “pixels forming characters” when there is a difference in quantity of enhancement. Also, by including a signal to discriminate “black character” from the other in the DSC signal used as the reference when an LUT is selected in the conversion information selection unit 104, it is possible to discriminate pixels forming a black character from pixels forming a color character, which in turn enables the enhancement quantity conversion unit 105 to convert a quantity of enhancement for a black character independently.

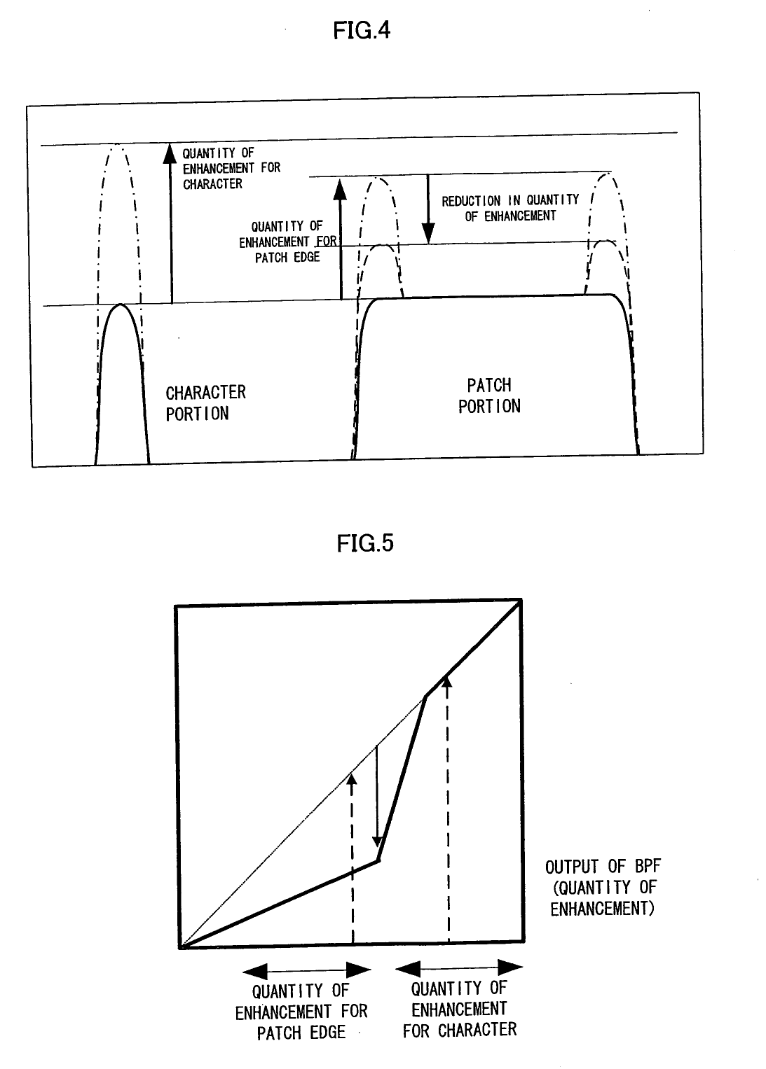

The quantity of enhancement, Δx, outputted as the result of the filter processing in the band-pass filter 103 varies with the kind of image in the document formed of a pixel subjected to the filter processing. For example, for a pixel forming a character or a line, a quantity of enhancement is large, whereas a quantity of enhancement for a pixel forming the edge portion of the patch region is not as large as that for a character (see FIG. 4).

The enhancement quantity conversion unit 105 exploits this characteristic, and leaves a quantity of enhancement intact for image signals of pixels forming a character portion for which the sharpness effect is needed, and reduces a quantity of enhancement for image signals of pixels forming the edge portion of the patch region for which enhancement needs to be suppressed, using, for example, the LUT as shown in FIG. 5. When configured in this manner, a quantity of enhancement can be reduced for pixels forming the edge portion of the patch region in comparison with a case where no enhancement quantity conversion processing is performed by the enhancement quantity conversion unit 105 (see FIG. 4).

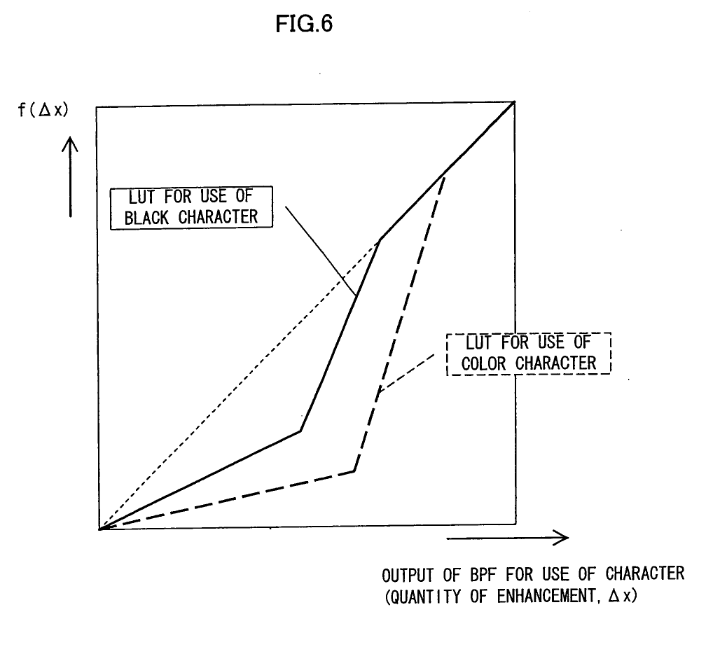

Generally, a primary importance is placed on reproduction (enhancement) of “black character” when the filter processing is performed. Hence, in this embodiment, the degree of enhancement quantity conversion is differentiated between “color character” and “black character” (see FIG. 6) by using an LUT having a primary importance on characters for pixels identified as forming “black characters”, and by using an LUT taking the balance between characters and the rest portion into account for pixels identified as forming “color characters”. For pixels identified as forming “photograph”, a filter parameter for use of photograph is adopted. A quantity of enhancement is therefore different from that in the portion identified as forming characters, and an LUT different from an LUT used in the case of “characters” is used.

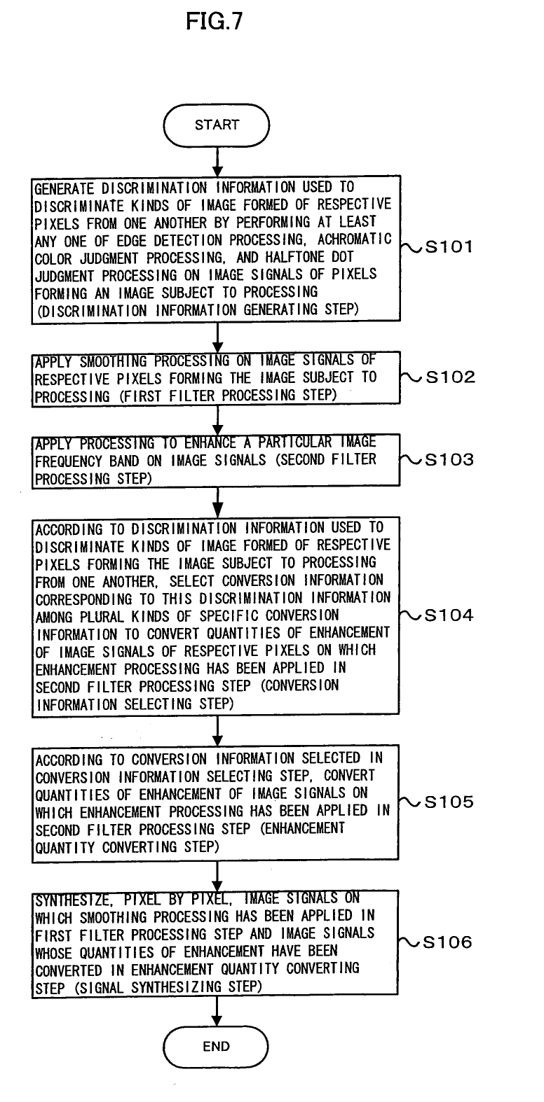

FIG. 7 is a flowchart used to describe the flow of processing (image processing method) by the image processing apparatus according to this embodiment.

The discrimination information generation unit 101 generates discrimination information used to discriminate kinds of image formed of the respective pixels from one another by performing at least any one of the edge detection processing, the achromatic color judgment processing, and the halftone dot judgment processing on image signals of pixels forming an image subject to processing (discrimination information generating step) (S101).

The discrimination information is information to discriminate pixels forming an image of at least any one of a black character, a color character, and a photograph from the others.

The first filter processing unit 102 applies the smoothing processing on image signals of respective pixels forming the image subject to processing (first filter processing step) (S102).

The second filter processing unit 103 applies processing to enhance a particular image frequency band on the image signals (second filter processing step) (S103).

The conversion information selection unit 104 acquires the discrimination information to discriminate kinds of image formed of the respective pixels forming the image subject to processing from one another. According to the acquired discrimination information, the conversion information selection unit 104 then selects conversion information corresponding to this discrimination information among plural kinds of specific conversion information to convert quantities of enhancement of image signals of respective pixels on which the enhancement processing has been applied in the second filter processing step (conversion information selecting step) (S104).

According to the conversion information selected in the conversion information selecting step, the enhancement quantity conversion unit 105 converts quantities of enhancement of image signals on which the enhancement processing has been applied in the second filter processing step (enhancement quantity converting step) (S105).

The signal synthesis unit 106 synthesizes, pixel by pixel, the image signals on which the smoothing processing has been applied in the first filter processing step and the image signals whose quantities of enhancement have been converted in the enhancement quantity converting step (signal synthesizing step) (S106).

The second filter processing unit 103 applies the enhancement processing to enhance image signals of pixels forming characters in the image subject to processing in comparison with image signals of pixels forming the edge portion of the patch region (second filter processing step). Of the image signals on which the enhancement processing has been applied in the second filter processing step, the enhancement quantity conversion unit 105 reduces a quantity of enhancement for image signals of pixels forming the edge portion of the patch region according to the conversion information selected in the conversion information selecting step (enhancement quantity converting step).

The flowchart described above shows a case where the discrimination information generating step is performed first followed sequentially by the first filter processing step and the second filter processing step. However, the order is not limited to this case, and the order is not particularly limited as long as the first filter processing step is performed before the execution of the signal synthesizing step and the second filter processing step is performed before the enhancement quantity converting step.

Each step of the processing in the image processing apparatus described above is exerted by causing the CPU 801 to execute the image processing program stored in the memory 802 on the basis of image processing information stored in the memory 802 and outside input information, such as control panel settings and printer driver settings, and by setting the results in the image processing apparatus.

This embodiment has described a case where functions needed to practice the invention have been previously recorded inside the apparatus. The invention, however, is not limited to this case, and the same functions may be down loaded to the apparatus via a network, or a recording medium having stored the same functions may be installed in the apparatus. The recording medium can be of any type, such as a CD-ROM, as long as it is a recording medium capable of storing the program and readable by the apparatus. Also, the functions obtained by way of pre-installment or downloading as described above may be exerted in cooperation with the OS (Operating System) or the like inside the apparatus.

As has been described, according to this embodiment, by providing an LPF (Low-Pass Filter) that performs the smoothing processing and a BPF (Band-Pass Filter) that performs the enhancement processing separately, and by further providing the enhancement quantity conversion processing using an LUT (Look-Up Table) in response to the DSC signal at the stage after the BPF, it is possible to convert the degree of enhancement non-linearly in response to the image signal level (quantity of enhancement) after the BPF processing. A quantity of enhancement can be thus controlled in response to the characteristic of an image using a simple hardware configuration by setting an LUT such that leaves a quantity of enhancement intact (or further increases a quantity of enhancement) for characters and lines having a large quantity of enhancement and reduces a quantity of enhancement for an edge portion in the patch region where enhancement needs to be suppressed.

Further, by using a character discrimination signal to discriminate finely between black characters and color characters for an enhancement quantity conversion LUT, it is possible to achieve an effect of differentiating processing for black characters for which the sharpness effect is particularly needed from processing for color characters for which a quantity of enhancement needs to be controlled.

While the present invention has been described in detail by way of a particular embodiment, it is obvious to those skilled in the art that various modifications and alternations are possible without deviating from the spirit and the scope of the invention.

As has been described in detail, the present invention can provide an image processing technique for enabling a quantity of enhancement to be controlled in response to the characteristic of an image using a simple configuration.

What is claimed is:

1. An image processing apparatus, comprising:
a first filter processing unit configured to apply smoothing processing on image signals of respective pixels forming an image subject to processing;
a second filter processing unit configured to apply processing to enhance a particular image frequency band on the image signals;
a conversion information selection unit configured to select, according to discrimination information used to discriminate kinds of image formed of the respective pixels forming the image subject to processing from one another, conversion information corresponding to the discrimination information among plural kinds of specific conversion information used to convert quantities of enhancement of the image signals of the respective pixels on which enhancement processing has been applied in the second filter processing unit;
an enhancement quantity conversion unit configured to convert the quantities of enhancement of the image signals on which the enhancement processing has been applied in the second filter processing unit according to the conversion information selected in the conversion information selection unit; and
a signal synthesis unit configured to synthesize, pixel by pixel, the image signals on which the smoothing processing has been applied in the first filter processing unit and the image signals whose quantities of enhancement have been converted in the enhancement quantity conversion unit.

2. The image processing apparatus according to claim 1, wherein:
the second filter processing unit applies the enhancement processing to enhance image signals of pixels forming characters in the image subject to processing in comparison with image signals of pixels forming an edge portion of a patch region; and
the enhancement quantity conversion unit reduces, of the image signals on which the enhancement processing has been applied in the second filter processing unit, quantities of enhancement of the image signals of pixels forming the edge portion of the patch region according the conversion information selected in the conversion information selection unit.

3. The image processing apparatus according to claim 1, wherein:
the discrimination information is information used to discriminate pixels forming an image of at least any one of a black character, a color character, and a photograph from the others.

4. The image processing apparatus according to claim 1, further comprising:
a discrimination information generation unit configured to generate the discrimination information used to discriminate kinds of image formed of the respective pixels from one another by performing at least any one of edge detection processing, achromatic color judgment processing, and halftone dot judgment processing on the image signals of the pixels forming the image subject to processing,
wherein the conversion information selection unit acquires the discrimination information generated in the discrimination information generation unit.

5. An image processing apparatus, comprising:
first filter processing means for applying smoothing processing on image signals of respective pixels forming an image subject to processing;
second filter processing means for applying processing to enhance a particular image frequency band on the image signals;
conversion information selecting means for selecting, according to discrimination information used to discriminate kinds of image formed of the respective pixels forming the image subject to processing from one another, conversion information corresponding to the discrimination information among plural kinds of specific conversion information used to convert quantities of enhancement of the image signals of the respective pixels on which enhancement processing has been applied in the second filter processing means;
enhancement quantity converting means for converting the quantities of enhancement of the image signals on which the enhancement processing has been applied in the second filter processing means according to the conversion information selected in the conversion information selecting means; and
signal synthesizing means for synthesizing, pixel by pixel, the image signals on which the smoothing processing has been applied in the first filter processing means and the image signals whose quantities of enhancement have been converted in the enhancement quantity converting means.

6. The image processing apparatus according to claim 5, wherein:
the second filter processing means applies the enhancement processing to enhance image signals of pixels forming characters in the image subject to processing in comparison with image signals of pixels forming an edge portion of a patch region; and
the enhancement quantity converting means reduces, of the image signals on which the enhancement processing has been applied in the second filter processing means, quantities of enhancement of the image signals of pixels forming the edge portion of the patch region according the conversion information selected in the conversion information selecting means.

7. The image processing apparatus according to claim 5, wherein:
the discrimination information is information used to discriminate pixels forming an image of at least any one of a black character, a color character, and a photograph from the others.

8. The image processing apparatus according to claim 5, further comprising:
discrimination information generating means for generating the discrimination information used to discriminate kinds of image formed of the respective pixels from one another by performing at least any one of edge detection processing, achromatic color judgment processing, and halftone dot judgment processing on the image signals of the pixels forming the image subject to processing,
wherein the conversion information selecting means acquires the discrimination information generated in the discrimination information generating means.

9. An image forming apparatus, comprising:
the image processing apparatus according to claim 5; and image forming means for forming an image on a sheet according to the image signal synthesized in the signal synthesizing means.

10. An image processing method, comprising the steps of:
applying smoothing processing on image signals of respective pixels forming an image subject to processing as first filter processing;
applying processing to enhance a particular image frequency band on the image signals as second filter processing;
selecting, according to discrimination information used to discriminate kinds of image formed of the respective pixels forming the image subject to processing from one another, conversion information corresponding to the discrimination information among plural kinds of specific conversion information used to convert quantities of enhancement of the image signals of the respective pixels on which enhancement processing has been applied in the second filter processing step;
converting the quantities of enhancement of the image signals on which the enhancement processing has been applied in the second filter processing step according to the conversion information selected in the conversion information selecting step; and
synthesizing, pixel by pixel, the image signals on which the smoothing processing has been applied in the first filter processing step and the image signals whose quantities of enhancement have been converted in the enhancement quantity converting step.

11. The image processing method to claim 10, wherein:
in the second filter processing step, the enhancement processing is applied to enhance image signals of pixels forming characters in the image subject to processing in comparison with image signals of pixels forming an edge portion of a patch region; and
in the enhancement quantity converting step, of the image signals on which the enhancement processing has been applied in the second filter processing step, quantities of enhancement of the image signals of pixels forming the edge portion of the patch region are reduced according the conversion information selected in the conversion information selecting step.

12. The image processing method according to claim 10, wherein:
the discrimination information is information used to discriminate pixels forming an image of at least any one of a black character, a color character, and a photograph from the others.

13. The image processing method according to claim 10, further comprising the step of:
generating the discrimination information used to discriminate kinds of image formed of the respective pixels from one another by performing at least any one of edge detection processing, achromatic color judgment processing, and halftone dot judgment processing on the image signals of the pixels forming the image subject to processing,
wherein, in the conversion information selecting step, the discrimination information generated in the discrimination information generating step is acquired.
